(19) United States
(12) Patent Application Publication
(10) Pub. No.: US 2023/0336551 A1
(43) Pub. Date: Oct. 19, 2023

(54) METHOD AND DEVICE FOR PROVIDING WEB PAGE USING CAPTIVE PORTAL

(71) Applicant: DANBI KOREA CORP., Jeollabuk-do (KR)

(72) Inventor: Gyeong Nam Kong, Seoul (KR)

(21) Appl. No.: 17/914,071

(22) PCT Filed: Jan. 29, 2021
(86) PCT No.: PCT/KR2021/001207

§ 371 Date: Dec. 23, 2022

(30) Foreign Application Priority Data
Mar. 24, 2020 (KR) 10-2020-0035804

(51) Int. Cl. H04L 9/40; H04W 12/086

(52) U.S. Cl. CPC H04L 63/10; H04W 12/086

(57) ABSTRACT

A method of providing a web page by using a captive portal includes obtaining a plurality of pieces of target web page information, in response to receiving a network connection request from a user terminal, transmitting a virtual signal to a captive portal providing apparatus, transmitting first target web page information to the user terminal, in response to receiving a user input to a first target web page through the user terminal, and transmitting second target web page information to the user terminal, in which the virtual signal is a signal indicating that the user terminal is not connected to a network, and the user terminal is a terminal that is not granted a network use right.

### TECHNICAL FIELD

The present disclosure relates to a method and device for providing a web page by using a captive portal. In particular, it relates to a method and device for providing a web page by using a captive portal without network authentication.

### BACKGROUND ART

A captive portal is a web browser that is displayed before granting a user terminal newly connected to a Wi-Fi network access to network resources. Typically, a captive portal is used for the purpose of collecting customer data or exposing advertisement contents. In other words, a network provider performs unilateral provision or collection of information by using a captive portal.

However, as the captive portal is a web browser that is accessible without additional user authentication, the usability of the captive portal is very high. Furthermore, by securing the scalability of the captive portal, a user's network accessibility and user convenience may be greatly improved. Accordingly, it is required to provide a method that may provide various web services by using the captive portal.

### DESCRIPTION OF EMBODIMENTS

### Technical Problem

Embodiments of the present disclosure provide a method and device for providing various web services by using a captive portal without additional user authentication.

### Solution to Problem

According to an embodiment of the present disclosure, a method of providing a web page by using a captive portal is performed by a computer apparatus and includes obtaining a plurality of pieces of target web page information, in response to receiving a network connection request from a user terminal, transmitting a virtual signal to a captive portal providing apparatus, transmitting first target web page information to the user terminal, and in response to receiving a user input to a first target web page through the user terminal, transmitting second target web page information to the user terminal, wherein the virtual signal is a signal indicating that the user terminal is not connected to a network, and the user terminal is a terminal that is not granted a network use right.

In an embodiment, the plurality of pieces of target web page information may be received from an external apparatus to be displayed by using the captive portal.

In an embodiment, the transmitting of the virtual signal may include stopping the transmitting of the virtual signal, in response to receiving a network disconnection signal of the target web page from the user terminal.

In an embodiment, the transmitting of the second target web page information may include transmitting third target web page information to the user terminal, in response to the user terminal using the captive portal satisfying a certain condition.

According to another embodiment of the present disclosure, an apparatus for providing a web page by using a captive portal includes a processor, wherein the processor is configured to obtain a plurality of pieces of target web page information, transmit a virtual signal to a captive portal providing apparatus, in response to receiving a network connection request from a user terminal, transmit first target web page information to the user terminal, and transmit second target web page information to the user terminal, in response to receiving a user input to a first target web page through the user terminal, the virtual signal is a signal indicating that the user terminal is not connected to a network, and the user terminal is a terminal that is not granted a network use right.

In an embodiment, the plurality of pieces of target web page information may be received from an external apparatus to be displayed by using the captive portal.

In an embodiment, the processor may be further configured to stop the transmitting of the virtual signal, in response to receiving a network disconnection signal of a target web page from the user terminal.

In an embodiment, the processor may be further configured to transmit third target web page information to the user terminal, in response to the user terminal using the captive portal satisfying a certain condition.

### BRIEF DESCRIPTION OF DRAWINGS

FIGS. 1 and 2 illustrate examples of a system for providing a web page by using a captive portal, according to an embodiment of the present disclosure.

FIG. 3 is a block diagram illustrating a configuration and operation of an apparatus for providing a web page by using a captive portal, according to an embodiment of the present disclosure.

FIG. 4 is a flowchart of a method of providing a web page by using a captive portal, according to an embodiment of the present disclosure.

FIGS. 5 to 9 illustrate examples of a web page provided by using a captive portal, according to an embodiment of the present disclosure.

### MODE OF DISCLOSURE

Embodiments will be described in detail with reference to the accompanying drawings, and in the description with reference to the drawings. This embodiment is described in sufficient detail so that a person skilled in the art is able to practice the present disclosure. It should be understood that the various embodiments of the present disclosure are different, but need not be mutually exclusive. For example, particular shapes, structures, and characteristics in the specification may be implemented by being changed from one embodiment to another embodiment without deviating from the spirit and scope of the disclosure. Furthermore, the position and arrangement of individual constituent elements in each embodiment may be understood to be modified without deviating from the spirit and scope of the disclosure. Accordingly, the following detailed description may not be interpreted to have a limiting meaning, and the scope of the disclosure may be interpreted to encompass the scope claimed by the claims and all scopes equivalent thereto. In the drawings, similar reference numerals denote the same or similar elements in various aspects.

In the following description, embodiments are provided to further completely explain the disclosure to one of ordinary skill in the art to which the disclosure pertains. However, the disclosure is not limited thereto and it will be understood that various changes in form and details may be made therein without departing from the spirit and scope of the following claims.

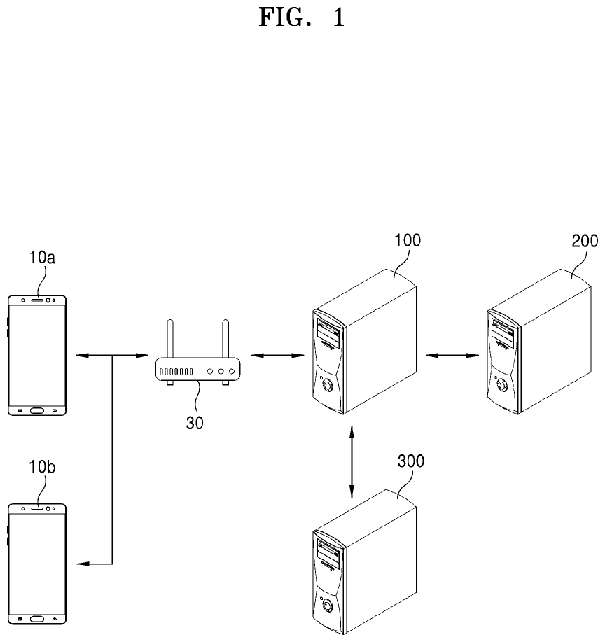

Hereinafter, a system for providing a web page by using a captive portal, according to an embodiment of the present disclosure, is described in detail with reference to FIG. 1.

Typically, a captive portal is provided by a captive portal providing apparatus 200, in response to network connection request signals of user terminals 10a and 10b via a gateway 30. In this case, a web page using a captive portal is displayed on the user terminals 10a and 10b through a web page transmission process from an external apparatus 300 to the user terminals 10a and 10b. As the captive portal is a web browser that is displayed before granting access to network resources to a user terminal newly connected to a Wi-Fi network, according to the related art, only a designated web page may be displayed on the user terminals 10a and 10b, and the use of other web pages is limited before access to the network resources is granted. In other words, the captive portal providing apparatus 200 blocks the user terminal's access to a web page other than the designated web page, before the network use right for the user terminal is granted.

A web page providing apparatus 100 providing a web page by using a captive portal, according to some embodiments of the present disclosure, may transmit a virtual signal to the captive portal providing apparatus 200, in response to receiving the network connection request signals of the user terminals 10a and 10b obtained via the gateway 30. The above-described virtual signal may be a signal indicating that a corresponding user terminal is not connected to a network.

In other words, the captive portal providing apparatus 200 that received the virtual signal transmitted by the web page providing apparatus 100 may recognize that the user terminals 10a and 10b are not connected to the network. Accordingly, even when the user terminals 10a and 10b access one or more web pages by using a captive portal, the captive portal providing apparatus 200 does not block the access to the web pages described above.

In detail, the web page providing apparatus 100 described above may obtain a plurality of pieces of target web page information from the external apparatus 300, or obtain a plurality of pieces of target web page information from a storage medium.

Furthermore, the web page providing apparatus 100 may transmit the virtual signal to the captive portal providing apparatus 200, in response to receiving the network connection requests from the user terminals 10a and 10b. Then, the web page providing apparatus 100 may transmit first target web page information to the user terminals 10a and 10b. The web page providing apparatus 100 may transmit second target web page information to the user terminals 10a and 10b, in response to receiving a user input to a first target web page through the user terminals 10a and 10b.

In other words, unlike the related art in which the provision of an additional web page to a user terminal having no network use right has been blocked by the captive portal providing apparatus 200, the web page providing apparatus 100 according to some embodiments of the present disclosure may provide one or more web pages to a user terminal having no network use right.

As such, a user may receive various web services without additional procedures to use a network, and a web service provider may provide various contents by using a captive portal.

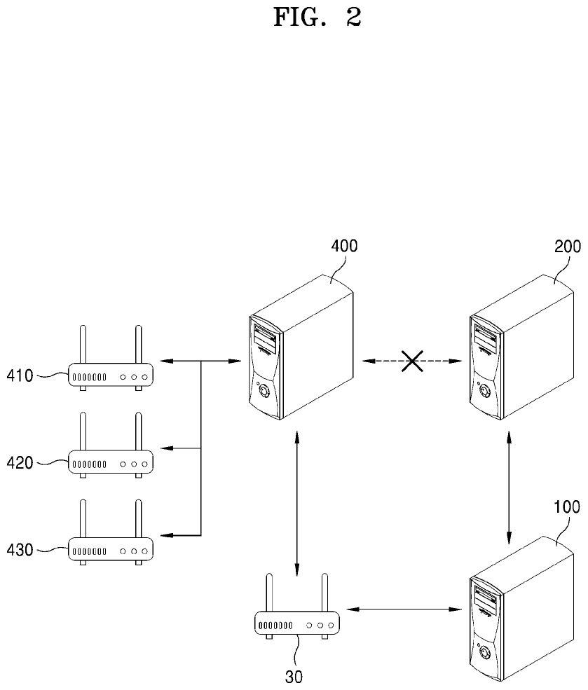

A system for providing a web page by using a captive portal, according to an embodiment of the present disclosure, is described with reference to FIG. 2.

According to the related art, a network connection request signal of a user terminal received using a plurality of gateways 410, 420, and 430 is transmitted to the captive portal providing apparatus 200 through a server 400 connected to the gateways 410, 420, and 430.

Contrary to the above, a web page providing system according to an embodiment of the present disclosure may transmit the network connection request signal described above to the web page providing apparatus 100 from the server 400 connected to the gateways 410, 420, and 430, and then, the web page providing apparatus 100 may transmit a virtual signal to the captive portal providing apparatus 200.

When a web service is provided using the gateways 410, 420, and 430, connecting the web page providing apparatus 100 according to some embodiments of the present disclosure to each of a plurality of gateways may be costly.

In the web page providing system accordingly an embodiment, the gateway 30 capable of communicating with the web page providing apparatus 100 may be further connected to the server 400 connected to the gateways 410, 420, and 430.

However, the system diagram of FIG. 2 is an example, and in an embodiment, it is not necessary for the gateway 30, which is capable of communicating with the web page providing apparatus 100, to be provided as physically separated hardware, and as an example, the server 400 connected to the gateways 410, 420, and 430 described above and the web page providing apparatus 100 may have direct communication. Even in this case, the server 400 connected to the gateways 410, 420, and 430 and the captive portal providing apparatus 200 do not have direct communication, and the virtual signal is transmitted to the captive portal providing apparatus 200 via the web page providing apparatus 100.

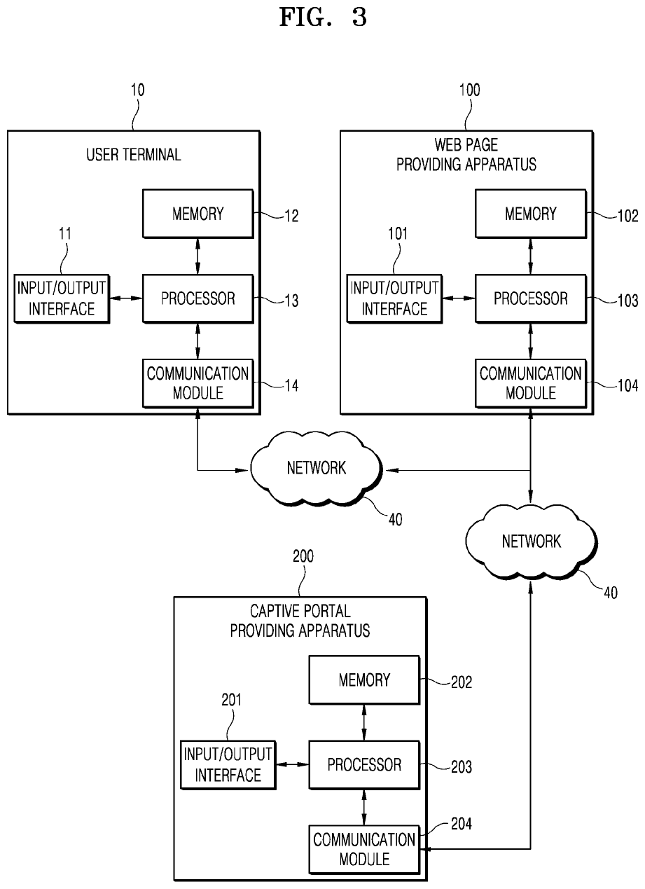

FIG. 3 is a hardware block diagram illustrating the configuration and operation of the web page providing apparatus 100, according to an embodiment of the present disclosure.

In an embodiment, a user terminal 10 displaying a web page, the web page providing apparatus 100 providing a web page, and the captive portal providing apparatus 200 providing a captive portal may respectively include input/output interfaces 11, 101, and 201, memories 12, 102, and 202, processors 13, 103, and 203, and communication modules 14, 104, and 204.

The input/output interfaces 11, 101, and 201 may each receive a user input, and display output data. The input/output interface 11 of the user terminal 10 according to an embodiment may display a web page by using a captive portal, and receive a user input to the web page.

The memories 12, 102, and 202 may include, as a computer-readable recording medium, random access memory (RAM), read only memory (ROM), and a permanent mass storage device, such as a disk drive. Furthermore, the memory 12 may temporarily or permanently store program code and settings to control the user terminal 10, camera images, and pose data of an object.

The processors 13, 103, and 203 may be configured to process instructions of a computer program, by performing basic arithmetic, logic, and input/output operations. The instructions may be provided by the memories 12, 102, and 202 or the communication modules 14, 104, and 204 to the processors 13, 103, and 203. For example, the processors 13, 103, and 203 may be configured to execute an instruction received according to the program code stored in a recording device, such as the memories 12, 102, and 202.

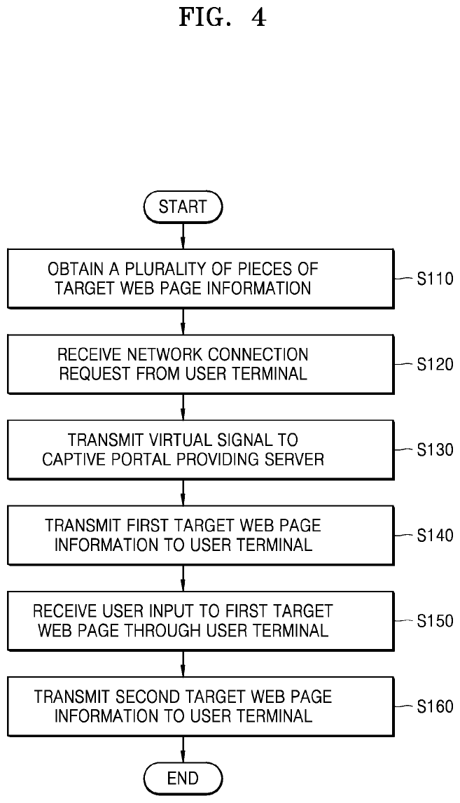

The processor 103 and the constituent elements of the processor 103 may control the web page providing apparatus 100 to perform operations S110 to S160 of the method of providing a web page of FIG. 4. For example, the processors 13, 103, and 203 and the constituent elements of the processors 13, 103, and 203 may be implemented to execute instructions according to code of an operating system included in the memories 12, 102, and 202 and code of at least one program.

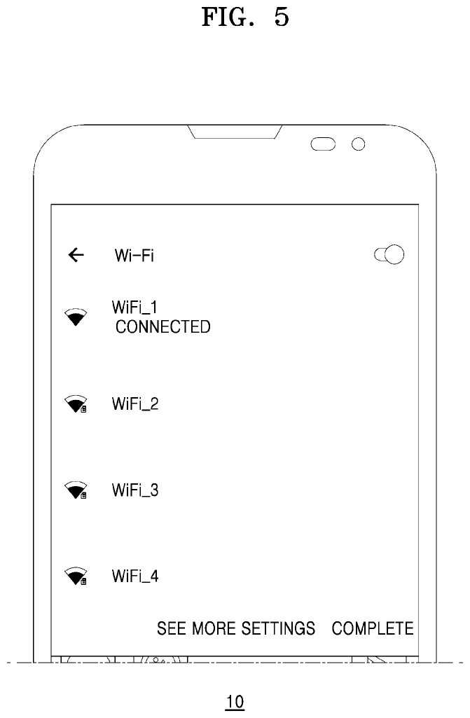

The constituent elements of the processors 13, 103, and 203 may be expressions of different functions of the processors 13, 103, and 203 performed by the processors 13, 103, and 203 according to the instructions provided by the program code stored in the memories 12, 102, and 202. The internal configurations and detailed operations of the processors 13, 103, and 203 are described with reference to a method of providing a web page of FIG. 4 and embodiments of FIGS. 5 to 9.

In an embodiment, the processor 103 of the web page providing apparatus 100 may obtain a plurality of pieces of target web page information, transmit a virtual signal to the captive portal providing apparatus 200, in response to receiving a network connection request from a user terminal, transmit first target web page information to the user terminal, and transmit second target web page information to the user terminal, in response to receiving a user input to a first target web page through the user terminal, and the virtual signal may be a signal indicating that the user terminal is not connected to a network.

The communication modules 14, 104, and 204 may provide a function to communicate through a network 40. For example, a request generated by the processor 13 of the user terminal 10 according to the program code stored in a recording device, such as the memory 12, may be transmitted to the web page providing apparatus 100 via the network 40 under the control of the communication module 14. Conversely, control signals, instructions, contents, files, and the like provided under the control of the processor 103 of the web page providing apparatus 100 may be received by the user terminal 10 via the network 40 through the communication module 14.

Furthermore, the virtual signal generated under the control of the processor 103 of the web page providing apparatus 100 may be transmitted to the captive portal providing apparatus 200 via the network 40.

In addition, the control signals, instructions, or the like of the web page providing apparatus 100, which are received through the communication module 14 of the user terminal 10, may be transmitted to the processor 13 or the memory 12, and the contents, files, or the like may be stored in a storage medium that the user terminal 10 may further include.

Furthermore, although the communication method of the communication modules 14, 104, and 204 is not limited, the network 40 may be a short-range wireless communication network. For example, the network 40 may include Bluetooth, Bluetooth low energy (BLE), or a Wi-Fi communication network.

Furthermore, in other embodiments, the user terminal 10, the web page providing apparatus 100, and the captive portal providing apparatus 200 may each include more constituent elements than the constituent elements of FIG. 3. However, there is no need to clearly illustrate most of the related-art constituent elements.

For example, the user terminal 10 may include a battery and charging device to supply power to internal constituent elements of the user terminal 10, may be implemented to include at least some of the input/output interface described above, or may further include other constituent elements, such as a transceiver, a global positioning system (GPS) module, various sensors, a database, and the like.

FIG. 4 is a flowchart of a method of providing a web page by using a captive portal, according to an embodiment of the present disclosure.

Referring to FIG. 4, in operation S110, the web page providing apparatus 100 may obtain one or more pieces of target web page information. In an embodiment, a plurality of pieces of target web page information may be received from an external apparatus, and may be stored in a storage medium of the web page providing apparatus 100. The obtained one or more target web pages may be displayed on the user terminal 10 later through a captive portal.

In operation S120, the web page providing apparatus 100 may receive a network connection request from the user terminal 10. The web page providing apparatus 100 according to the present embodiment may not perform confirmation on the presence or absence of the network access rights of the user terminal 10 that tries a network connection.

In other words, a web page using a captive portal provided according to some embodiments of the present disclosure may be displayed on the user terminal 10 regardless of the presence or absence of the network access rights of the user terminal 10.

As an example, when the user terminal 10 tries to access a specific Wi-Fi network, the web page providing apparatus 100 may perform operation S130 described below in response to the Wi-Fi connection access.

In operation S130, the web page providing apparatus 100 may transmit a virtual signal to a captive portal providing server. Typically, a captive portal providing apparatus (or server) may block a network connection in response to a network connection request by a user terminal having no network connection right.

Accordingly, according to some embodiments of the present disclosure, the virtual signal transmitted by the web page providing apparatus 100 may be a fake signal indicating that the user terminal 10 is not connected to a network.

In other words, the captive portal providing apparatus 200 that receives the virtual signal transmitted by the web page providing apparatus 100 may recognized that the user terminal 10 are not connected to the network. Then, even when the user terminal 10 is connected to one or more web pages using a captive portal, the captive portal providing apparatus 200 does not block the connection to the web page described above.

In an embodiment, the web page providing apparatus 100 may stop the transmission of the virtual signal, in response to receiving a network disconnection signal of the target web page from the user terminal 10. In other words, in the present embodiment, the web page providing apparatus 100 may continuously transmit the virtual signal to the captive portal providing server when the user terminal 10 uses the network.

In operation S140, the web page providing apparatus 100 may transmit first target web page information to the user terminal 10. In operation S130, after transmitting the virtual signal to the captive portal providing server, one or more target web page information obtained in operation S110 may be transmitted to the user terminal 10. According to some embodiments of the present disclosure, the user terminal 10, even when having no network access right, may access the corresponding web page by using the target web page information received from the web page providing apparatus 100.

In operation S150, the web page providing apparatus 100 may receive a user input to a first target web page through the user terminal 10. In an embodiment, the user terminal 10 that receives the target web page information may display the web page through a display, and receive a user input to the web page through the input/output interface 11.

In an embodiment, the user input to the target web page may include a user input to a UI object displayed on the display of the user terminal 10. For example, when the first target web page includes advertisement contents about a specific product, in response to a user input to the UI object that displays the contents, the web page providing apparatus 100 may perform operation S160 described below and transmit sales page information about the specific product to the user terminal 10.

In operation S160, the web page providing apparatus 100 may transmit second target web page information to the user terminal 10. In other words, as described above, the web page providing apparatus 100 may transmit second target web page information different from the first target web page described above to the user terminal 10, in response to receiving a designated user input to the user terminal 10.

Likewise, when the web page providing apparatus 100 receives a designated user input to a second target web page through the user terminal 10, an access to other web pages may be performed. In other words, unlike the related art in which an access to a web page other than the designated contents using a captive portal is blocked, the web page providing apparatus 100 according to some embodiments of the present disclosure may provide various web pages according to the request of the web service provider or user.

Alternatively, in an embodiment, the web page providing apparatus 100 may further transmit third target web page information to the user terminal 10, in response to the user terminal 10 using a captive portal satisfying a certain condition. The certain condition may be assigned by a web page manufacturer. For example, when there is a usage history of the user terminal 10 about a specific web page, the web page providing apparatus 100 may transmit to the user terminal 10 web page information with previous web page usage records.

Alternatively, the web page providing apparatus 100 may transmit web page information with customized advertisement contents to the user terminal 10 by using specific information of a user of the user terminal 10. In other words, in the present embodiment, the web page providing apparatus 100 may transmit specific target web page information in response to user terminal information and/or user information satisfying a certain condition, regardless of a user input to the user terminal 10.

In other words, the web page providing apparatus 100 according to some embodiments of the present disclosure may provide one or more web pages to a user terminal having no network use right. Accordingly, the user terminal 10 may receive various web services without additional procedures to obtain a network use right, and the web service provider may provide various contents by using a captive portal.

FIGS. 5 to 9 illustrate examples of a web page provided by using a captive portal, according to an embodiment of the present disclosure. However, the display of the user terminal 10 illustrated in FIGS. 5 to 9 is an example for understanding of a method of providing a web page, according to some embodiments of the present disclosure, and it is noted that the method of providing a web page, according to some embodiments of the present disclosure, is not limited thereto.

The operation of a user terminal transmitting a network connection request, according to an embodiment of the present disclosure, is described below with reference to FIG. 5.

In an embodiment, the user terminal 10 may transmit sequential network connection request signals regarding available networks. Typically, a network displaying a captive portal does not set a separate password setting for network connection. Accordingly, with reference to FIG. 5, a case in which a network connection request signal of the user terminal 10 with respect to “WiFi_1” that is connectable is transmitted to the web page providing apparatus 100 is assumed and described.

In an embodiment, when there is a connection request of the user terminal 10 with respect to a connectable network, the web page providing apparatus 100 may transmit to the captive portal providing server a virtual fake signal indicating that the user terminal 10 is not connected to a network.

In other words, the captive portal providing apparatus that received the virtual signal transmitted by the web page providing apparatus 100 may recognize that the user terminal 10 is not connected to a network. Then, even when the user terminal 10 accesses one or more web pages by using a captive portal, the captive portal providing apparatus does not block the connection to the web page.

In this case, web page providing apparatus 100 may repeatedly transmit the virtual signal to the captive portal providing apparatus. In an embodiment, web page providing apparatus 100 may stop the transmission of the virtual signal, in response to receiving a network disconnection signal of the target web page from the user terminal 10. In other words, in the present embodiment, when the user terminal 10 uses the network, the web page providing apparatus 100 may continuously transmit the virtual signal to the captive portal providing server.

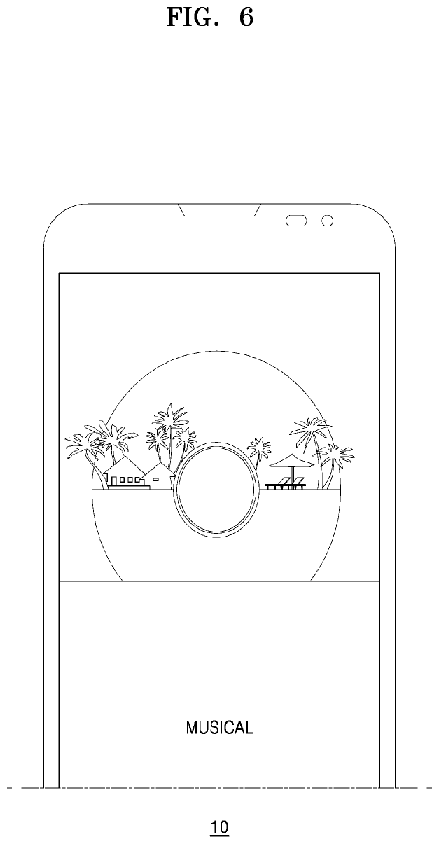

FIG. 6 illustrates an example of the display of the user terminal 10 displaying a web page transmitted by the web page providing apparatus 100, according to an embodiment of the present disclosure.

As illustrated in FIG. 6, in an embodiment, the user terminal 10 may display a first target web page displaying advertisement contents for sales of a specific product, by using a captive portal. Then, the user terminal 10 may transmit, in response to a user input to the web page, a second target web page request signal different from the first target web page described above, to web page providing apparatus 100 and/or a server providing the contents.

In a method of providing a web page, according to some embodiments of the present disclosure, unlike the related art, the network use of the user terminal 10 is not limited due to the virtual signal transmitted by the web page providing apparatus 100 to the captive portal providing apparatus, and the user terminal 10 may display a second target web page based on information received from the page providing apparatus and/or the server providing the contents.

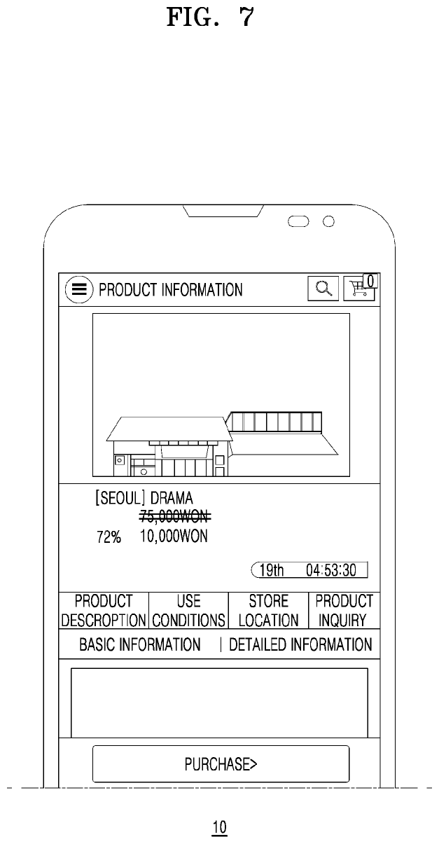

For example, the user terminal 10 may access a sales web page of the advertisement product as illustrated in FIG. 7, in response to a user input to a captive portal displaying a web page including the advertisement contents. In addition, then, the user terminal 10 according to some embodiments of the present disclosure may pay for a product in a captive portal by accessing a payment page of the product.

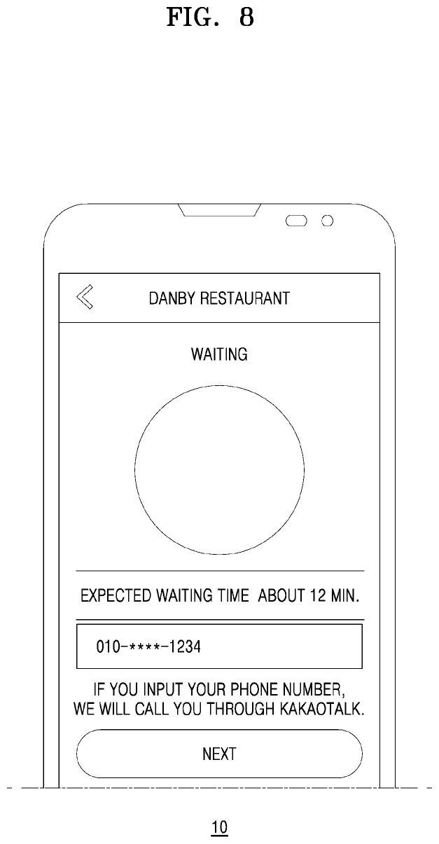

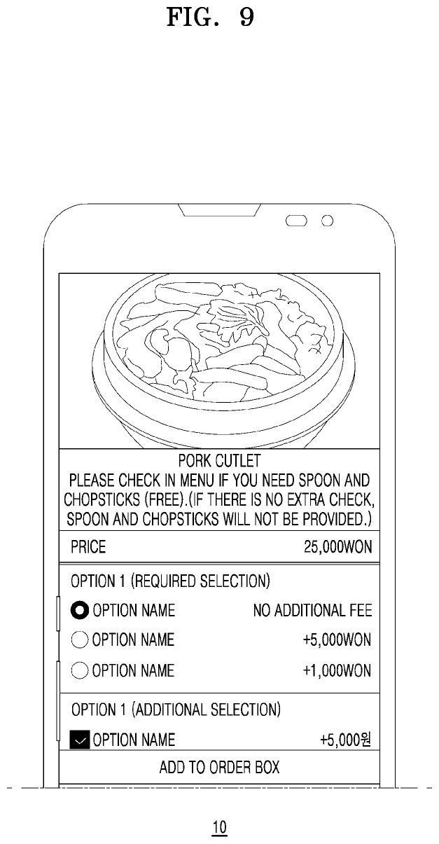

Alternatively, the user terminal 10 according to an embodiment of the present disclosure may use a web service provided by a specific company as illustrated in FIGS. 8 and 9. In an embodiment, the web page providing apparatus 100 may further transmit new target web page information to the user terminal 10, in response to the user terminal 10 using a captive portal satisfying a certain condition. The certain condition may be assigned by a web service provider.

For example, when there is the usage history of the user terminal 10 with respect to a specific web page, the web page providing apparatus 100 may transmit web page information personalized/customized to the user terminal 10 described above by using previous web page usage history.

Alternatively, the web page providing apparatus 100 may transmit web page information customized to the user terminal 10 using user specific information of the user terminal 10. In other words, in the present embodiment, the web page providing apparatus 100 may transmit specific target web page information in response to the information of the user terminal 10 and/or the user information satisfying a certain condition, regardless of the user input to the user terminal 10. Accordingly, the user may receive various web services without additional procedures to use a network, and the web service provider may provide various contents by using a captive portal.

For example, as illustrated in FIG. 8, a web page related to reservation/waiting of a restaurant may be displayed on a captive portal of the user terminal 10, and then, for the user entrance time/order of the user terminal 10, a new web page related to a food order may be displayed on the display of the user terminal 10 without additional user input.

The apparatus described above may be implemented by a hardware element, a software element, and/or a combination of a hardware element and a software element. For example, the apparatus and elements described in the embodiments may be implemented by using one or more general purpose computers or special purposed computers, for example, a processor, a controller, an arithmetic logic unit (ALU), a digital signal processor, a microcomputer, a field programmable gate array (FPGA), a programmable logic unit (PLU), a microprocessor, or any other apparatus capable of executing instructions and responding. A processing apparatus may perform an operating system (OS) and one or more software applications executed on the OS. Furthermore, the processing apparatus may access, store, manipulate, process and generate data in response to the execution of the software. For convenience of understanding, although it may be described that one processing apparatus is used, a person skilled in the art may see that the processing apparatus includes a plurality of processing elements and/or multiple types of processing elements. For example, the processing apparatus may include a plurality of processors or one processor and one controller. Furthermore, other processing configuration, such as a parallel processor, is possible.

Software may include a computer program, code, instructions, or a combination of one or more thereof, and may configure a processing apparatus to operate as desired or independently or collectively instruct the processing apparatus. Software and/or data may be embodied permanently or temporarily to any type of machine, a component, a physical device, virtual equipment, a computer storage medium or device, or transmitted signal waves, to be interpreted by a processing apparatus or provide instructions or data to a processing apparatus. Software may be distributed over networked computer systems, and may be stored or executed by a distributed method. Software and data may be stored in one or more computer-readable recording media.

A method according to an embodiment may be implemented in the form of a program instruction to be executed through various computer devices and recorded on a computer-readable medium. A computer-readable medium may include program instructions, data files, data structures, and the like solely or in combination. A program instruction recorded on a medium may be specially designed and configured for an embodiment or usable by being well known to a person skilled in the computer software art. Examples of a computer-readable recording medium may include hard discs, floppy discs, and magnetic tapes, optical media such as CD-ROM or DVD, magneto-optical media such as floptical disks, and hardware devices such as ROM, RAM flash memory, which are specially configured to store and execute a program command. An example of a program command may include not only machine codes created by a compiler, but also high-level programming language executable by a computer using an interpreter. The above-described hardware apparatuses may be configured to operate as one or more software modules to perform operations according to various embodiments of the disclosure, or vice versa.

As described above, although embodiments are described with reference to the limited embodiments and drawings, numerous modifications and adaptations will be readily apparent to one of ordinary skill in the art without departing from the spirit and scope of the disclosure. For example, an appropriate result may be achieved even when the described technologies are performed in a different order from the described method, and/or the constituent elements of the described system, structure, apparatus, circuit, and the like are coupled or combined in a different form from the described method, or replaced or substituted by other constituent elements or equivalents.

Thus, other implementations, another embodiments, and equivalents to the claims are within the scope of claims described below.

1. A method of providing a web page by using a captive portal, the method performed by a computer apparatus and comprising:
obtaining a plurality of pieces of target web page information;
in response to receiving a network connection request from a user terminal, transmitting a virtual signal to a captive portal providing apparatus;
transmitting first target web page information to the user terminal; and
in response to receiving a user input to a first target web page through the user terminal, transmitting second target web page information to the user terminal,
wherein the virtual signal is a signal indicating that the user terminal is not connected to a network, and the user terminal is a terminal that is not granted a network use right.

2. The method of claim 1, wherein the plurality of pieces of target web page information are received from an external apparatus to be displayed by using the captive portal.

3. The method of claim 1, wherein the transmitting of the virtual signal comprises stopping the transmitting of the virtual signal, in response to receiving a network disconnection signal of the target web page from the user terminal.

4. The method of claim 1, wherein the transmitting of the second target web page information comprises transmitting third target web page information to the user terminal, in response to the user terminal using the captive portal satisfying a certain condition.

5. An apparatus for providing a web page by using a captive portal, the apparatus comprising
a processor,
wherein the processor is configured to:
obtain a plurality of pieces of target web page information;
transmit a virtual signal to a captive portal providing apparatus, in response to receiving a network connection request from a user terminal; transmit first target web page information to the user terminal; and
transmit second target web page information to the user terminal, in response to receiving a user input to a first target web page through the user terminal,
the virtual signal is a signal indicating that the user terminal is not connected to a network, and
the user terminal is a terminal that is not granted a network use right.

6. The apparatus of claim 5, wherein the plurality of pieces of target web page information are received from an external apparatus to be displayed by using the captive portal.

7. The apparatus of claim 5, wherein the processor is further configured to stop the transmitting of the virtual signal, in response to receiving a network disconnection signal of a target web page from the user terminal.

8. The apparatus of claim 5, wherein the processor is further configured to transmit third target web page information to the user terminal, in response to the user terminal using the captive portal satisfying a certain condition.
